(19) United States
(12) Patent Application Publication
(10) Pub. No.: US 2026/0331794 A1
(43) Pub. Date: Oct. 22, 2026

(54) CONNECTING DEVICE

(71) Applicants: NEXTRONICS ENGINEERING CORP., New Taipei City (TW); MAKALOT INDUSTRIAL CO., LTD., Taipei City (TW)

(72) Inventors: HOU-AN SU, KEELUNG CITY (TW); KUAN-WEN CHEN, NEW TAIPEI CITY (TW); YU-TING SUN, Keelung City (TW); WEI-YI TSAI, Taipei City (TW); LI-XIANG LEE, Taipei City (TW); HANG-SHOU SHEU, Taipei City (TW)

(21) Appl. No.: 19/346,478

(22) Filed: Sep. 30, 2025

(30) Foreign Application Priority Data
Apr. 21, 2025 (TW) 114114889

(51) Int. Cl. H01R 12/53; H01R 12/70

(52) U.S. Cl. CPC H01R 12/53; H01R 12/707

(57) ABSTRACT

A connecting device for connecting an elastic wire assembly includes a fixing seat, a circuit board (FPC), and a connector. The elastic wire assembly includes elastic wires connected to a double-sided adhesive tape. The connector is soldered to the circuit board. When the fixing seat is assembled with the elastic wire assembly, a friction force generated from the elastic wire assembly passing through the fixing seat is used to fix the fixing seat and the elastic wire assembly together. The fixed seat has a lifting structure to lift the elastic wire assembly upward such that the lifting structure provides a contact force (positive force). Insulating paint covers a surface of the elastic wires and is removed by laser. The circuit board has metal contacts that correspond to the elastic wires. Protruding portions of the elastic wires are pressed to contact the metal contacts of the circuit board.

### CROSS-REFERENCE TO RELATED PATENT APPLICATION

This application claims the benefit of priority to Taiwan Patent Application No. 114114889, filed on Apr. 21, 2025. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a connecting device, and more particularly to a connecting device for connecting an elastic wire and a connector.

### BACKGROUND OF THE DISCLOSURE

In an application of elastic wires on fabrics, signals from various parts of the body can be transmitted to a device center for processing without losing the stretchability of the fabric, making it suitable for products such as functional clothing. Elastic wires have characteristics of being soft, stretchable, electrically conductive, and non-heat-resistant, such that the elastic wires are limited in terms of processing. In existing technology, soldering is used to connect the elastic wires and a connector to transmit electrical signals. However, the use of a thermal process (e.g., soldering) to connect the elastic wire and the connector is prone to damage to the elastic wire, thus resulting in great inconvenience in processing.

### SUMMARY OF THE DISCLOSURE

In response to the above-referenced technical inadequacies, the present disclosure provides a connecting device. The connecting device can connect an elastic wire and a connector to form a connection line having elastic function without requiring the use of a thermal process to connect the elastic wire and the connector, so as to avoid damaging the elastic wire.

In order to solve the above-mentioned problems, one of the technical aspects adopted by the present disclosure is to provide a connecting device for connecting an elastic wire assembly. The elastic wire assembly includes a plurality of elastic wires, and the connecting device includes: a fixing seat, a circuit board, and a connector. The fixing seat includes two cross bars and a lifting structure. The two cross bars are spaced apart from each other, the lifting structure is disposed between the two cross bars, and a through hole is formed between the lifting structure and the two cross bars. The elastic wire assembly is able to pass through the through hole, so that the elastic wire assembly passes through bottom sides of the two cross bars and a top side of the lifting structure, and the elastic wire assembly is bent and passes through the fixing seat. A plurality of first contacts and a plurality of second contacts are respectively disposed on two opposite sides of the circuit board. The connector includes a plurality of pins. The first contacts are respectively soldered to the plurality of pins of the connector, and the circuit board is disposed on the fixing seat. The plurality of elastic wires are lifted by the lifting structure, so that each of the plurality of elastic wires respectively form one of a plurality of protruding portions, and the plurality of protruding portions of the plurality of elastic wires are respectively in contact with the plurality of second contacts of the circuit board, so that the plurality of elastic wires are electrically connected to the connector through the circuit board.

Therefore, one of the beneficial effects of the present disclosure lies in that, the connecting device provided by the present disclosure includes a fixing seat, a circuit board and a connector. The fixing seat includes two cross bars and a lifting structure. The lifting structure is disposed between the two cross bars. A through hole is formed between the lifting structure and the two cross bars, so that the elastic wire assembly is able to pass through the through hole. Accordingly, the elastic wire assembly can pass through bottom sides of the two cross bars and a top side of the lifting structure, and the elastic wire assembly is bent and passes through the fixing seat. A plurality of first contacts and a plurality of second contacts are respectively disposed on two opposite sides of the circuit board. The first contacts are respectively soldered to a plurality of pins of the connector, and the circuit board is disposed on the fixing seat. The plurality of elastic wires are lifted by the lifting structure, so that each of the plurality of elastic wires respectively form one of a plurality of protruding portions, and the plurality of protruding portions of the plurality of elastic wires are respectively in contact with the plurality of second contacts of the circuit board, so that the plurality of elastic wires are electrically connected to the connector through the circuit board. In the present disclosure, a friction force from the elastic wire assembly passing through the fixing seat is used to fix the elastic wire assembly and the fixing seat in place, and the friction force between the elastic wire assembly and the fixing seat is increased. The structure of the fixing seat bends to form a path through which the elastic wire assembly passes, thereby increasing the friction force between the elastic wire assembly and the fixing seat and preventing the elastic wire assembly from easily falling off from the fixing seat. Accordingly, the fixing seat and the circuit board can clamp the elastic wire assembly. In addition, the expansion force of the plurality of elastic wires after compression allows the plurality of elastic wires to be better attached to the circuit board for electrical conduction. The connecting device of the present disclosure can facilitate the connection between the elastic wire and the connector without requiring the use of a thermal process to connect the elastic wire and the connector, so as to avoid damaging the elastic wire.

These and other aspects of the present disclosure will become apparent from the following description of the embodiment taken in conjunction with the following drawings and their captions, although variations and modifications therein may be effected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic perspective exploded view of a connecting device according to one embodiment of the disclosure;

FIG. 2 is a schematic perspective view of the connecting device according to one embodiment of the disclosure;

FIG. 3 is a cross-sectional view taken along line III-III in FIG. 2;

FIG. 4 is a schematic perspective exploded view of an elastic wire assembly and a fixing seat according to one embodiment of the disclosure;

FIG. 5 is another schematic perspective exploded view of the elastic wire assembly and the fixing seat according to one embodiment of the disclosure;

FIG. 6 is a schematic perspective exploded view of a circuit board and a connector according to one embodiment of the disclosure;

FIG. 7 is a schematic perspective exploded view of an elastic wire assembly, a fixing seat and a circuit board according to one embodiment of the disclosure; and

FIG. 8 is another schematic perspective view of the connecting device according to one embodiment of the disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

### Embodiments

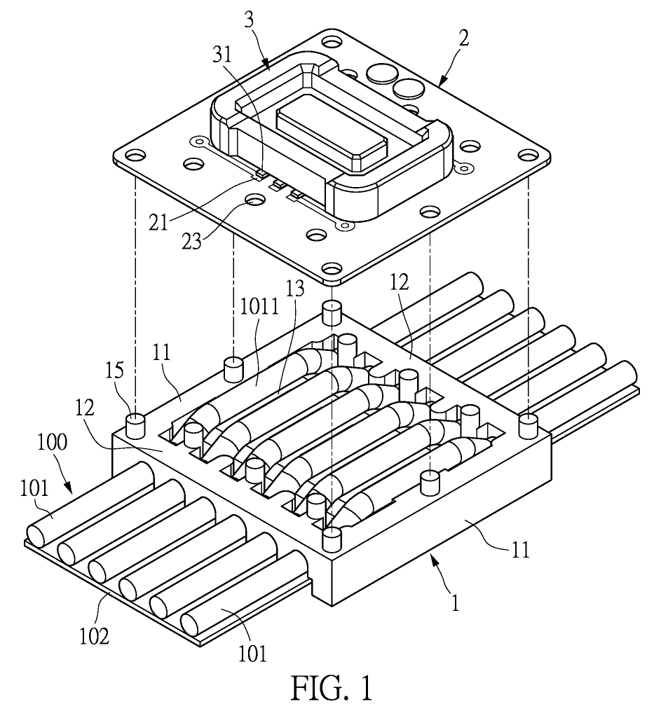

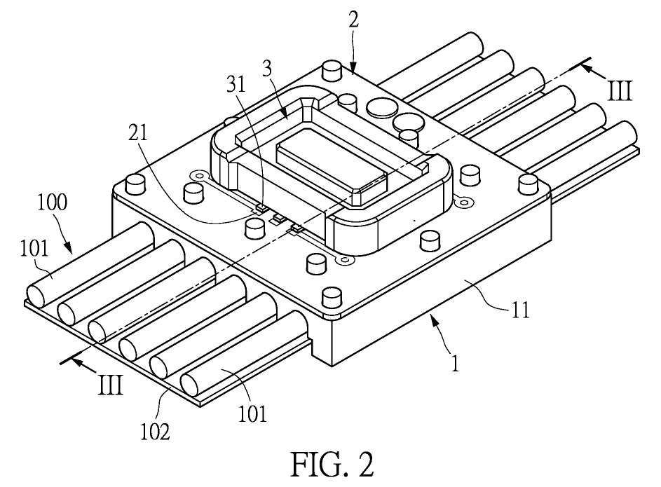

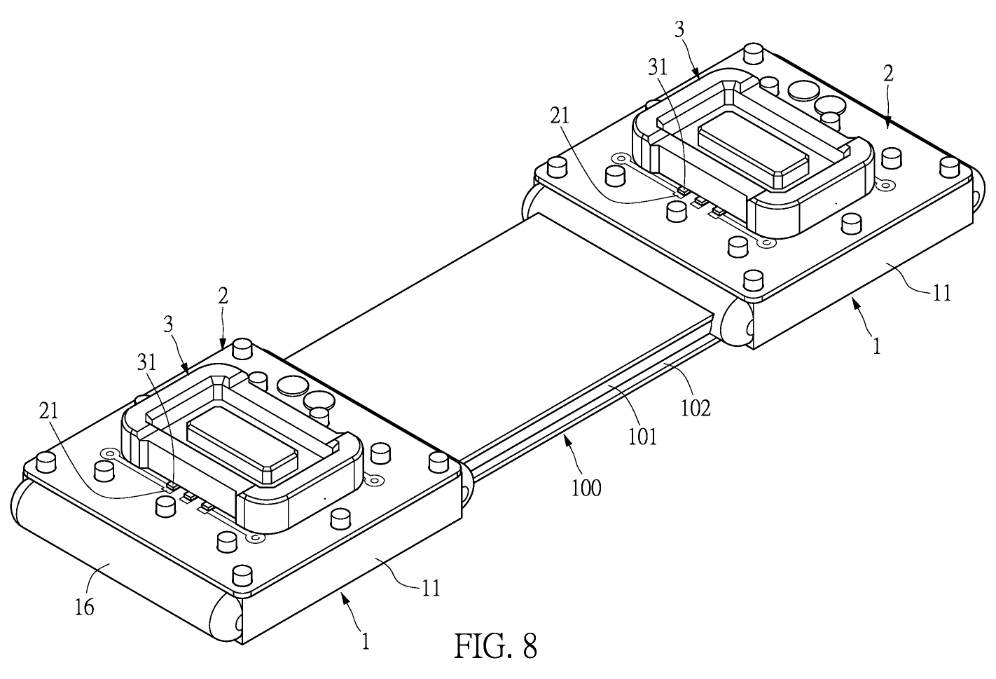

Referring to FIGS. 1-3, the present disclosure provides a connecting device for connecting an elastic wire assembly 100. The elastic wire assembly 100 includes a plurality of elastic wires 101, and the plurality of elastic wires 101 are formed by spirally winding a textile wire and a metal wire, and have soft, stretchable, and electrically conductive properties. The plurality of elastic wires 101 may also be connected to a double-sided adhesive tape 102. A quantity of the elastic wires 101 is not limited in the present disclosure. In this embodiment, a manner of connection uses six elastic wires 101 and a double-sided adhesive tape 102. The connecting device of the present disclosure can be adopted to two ends of the elastic wire assembly 100 (as shown in FIG. 8), and the connection device includes a fixing seat 1, a circuit board 2, and a connector 3.

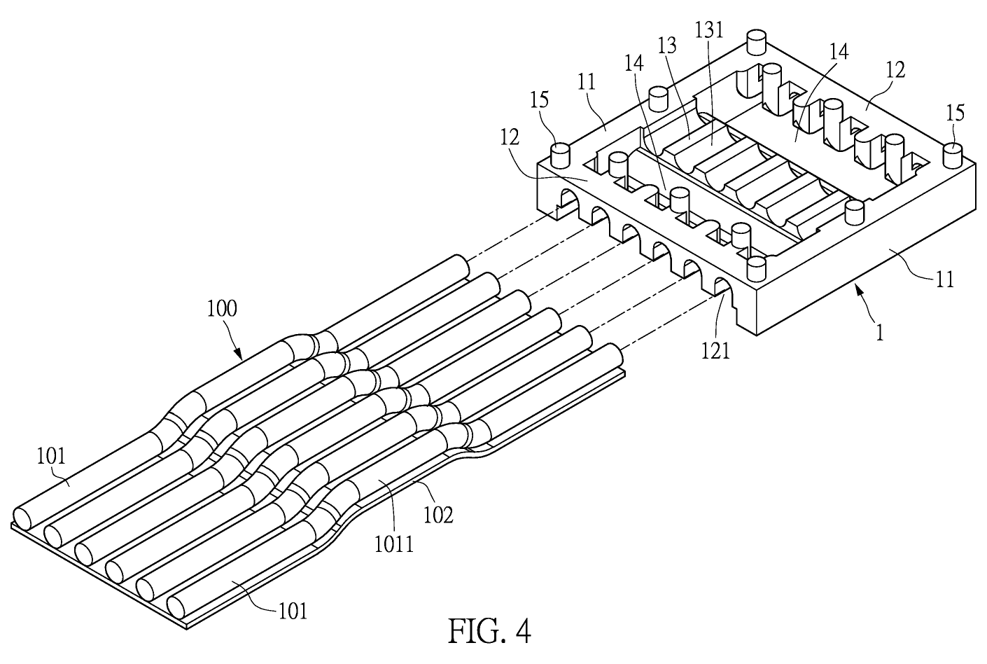

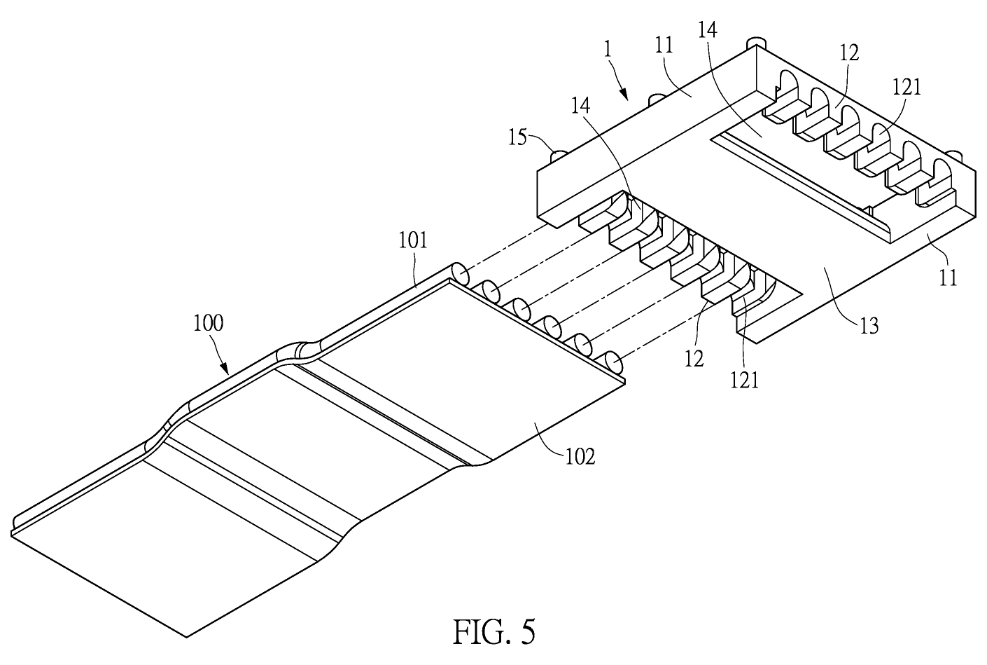

Referring to FIGS. 4 and 5, the fixing seat 1 can be made of insulating materials such as plastic, and the fixing seat 1 includes two cross bars 12 and a lifting structure 13. The two cross bars 12 are spaced apart from each other, and the lifting structure 13 is disposed between the two cross bars 12. The lifting structure 13 is arranged at intervals with the two cross bars 12, and the two cross bars 12 and the lifting structure 13 can be parallel to each other. In addition, two side bars 11 can be disposed between the two cross bars 12. The two side bars 11 can be arranged at intervals and can be parallel to each other. Two ends of each of the two cross bars 12 can be connected to two ends of each of the two side bars 11, respectively, such that the two side bars 11 and the two cross bars 12 can be used to form a frame body. Two ends of the lifting structure 13 can be respectively connected to the two side bars 11, such that the structure of the fixing seat 1 can be reinforced.

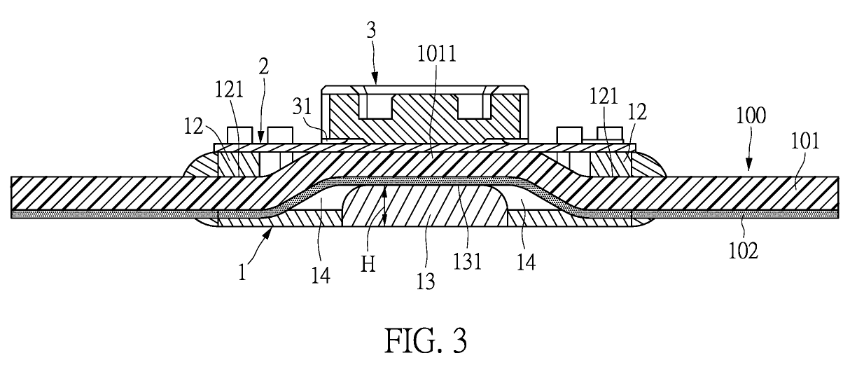

A through hole 14 is formed between the lifting structure 13 and each of the two cross bars 12 for the elastic wire assembly 100 to pass through the through hole 14. The lifting structure 13 can be located at a center of a bottom side of the fixing seat 1, and the lifting structure 13 may be equidistant from the two cross bars 12, such that the lifting structure 13 is located in the middle of the two cross bars 12, so as to have an improved lifting effect. The elastic wire assembly 100 passes through two opposite sides of the two cross bars 12 and the lifting structure 13. That is, the elastic wire assembly 100 can pass through bottom sides of the two cross bars 12 and a top side of the lifting structure 13, such that the elastic wire assembly 100 is bent and passes through the fixing seat 1. Accordingly, such design can effectively increase a friction force between the elastic wire assembly 100 and the fixing seat 1. Furthermore, the lifting structure 13 is used to provide a lifting effect to the plurality of elastic wires 101. The plurality of elastic wires 101 can be lifted by the lifting structure 13 to respectively form protruding portions 1011 that protrude upward, such that the protruding portions 1011 can be used to contact the circuit board 2. Preferably, the protruding portions 1011 are strip-shaped, and a length of each of the protruding portions 1011 is greater than a diameter of each of the plurality of elastic wires 101, such that a contact area can be larger to improve a conduction effect. The double-sided adhesive tape 102 of a position on the elastic wire assembly 100 corresponding to the lifting structure 13 is removed, such that the lifting structure 13 is in direct contact with the plurality of elastic wires 101, thereby improving the conduction effect of the plurality of elastic wires 101. If the double-sided adhesive tape 102 is not removed, the double-sided adhesive tape 102 may assist in lifting the elastic wire 101 (as shown in FIG. 3).

Referring to FIGS. 3-5, in this embodiment, the two cross bars 12 and the lifting structure 13 are located at different horizontal heights. The horizontal height of the two cross bars 12 is higher than the horizontal height of the lifting structure 13. The lifting structure 13 is located on the bottom side of the fixing seat 1, and the lifting structure 13 has a height H for being able to lift the elastic wire assembly 100 upward, such that the plurality of elastic wires 101 can protrude by a predetermined height.

In this embodiment, a plurality of first wire grooves 121 are formed at intervals on the two cross bars 12, and a plurality of second wire grooves 131 are formed at intervals on the lifting structure 13. The first wire grooves 121 and the second wire grooves 131 are respectively arranged on the two opposite sides of the cross bars 12 and the lifting structure 131. That is, the first wire grooves 121 are arranged at the bottom side of the cross bars 12, and the second wire grooves 131 are arranged on the top side of the lifting structure 13. The plurality of elastic wires 101 are respectively accommodated in the first wire grooves 121 and the second wire grooves 131, such that the plurality of elastic wires 101 can have a better positioning effect when they pass through the two opposite sides of the cross bars 12 and the lifting structure 13. However, the positioning method of the plurality of elastic wires 101 is not limited in the present disclosure. For example, other spacing structures may be provided to space apart and position the plurality of elastic wires 101.

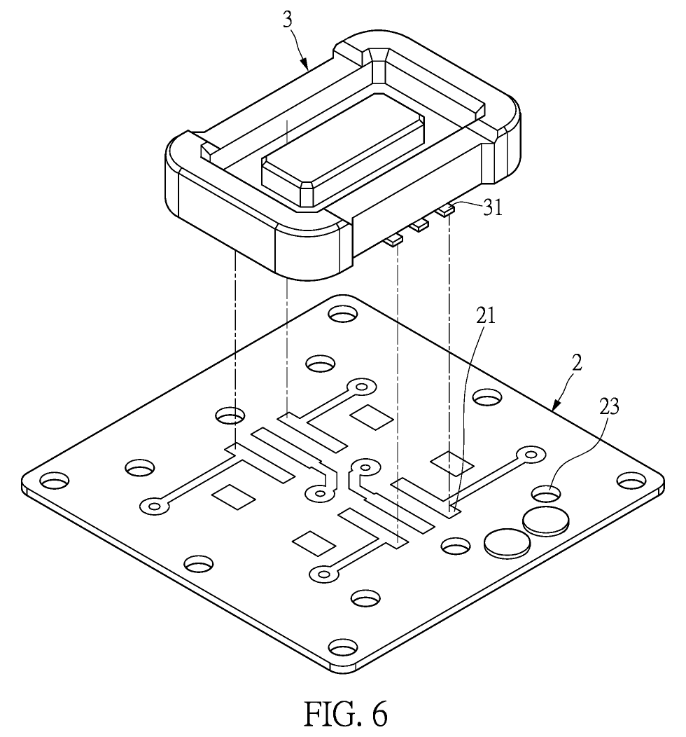

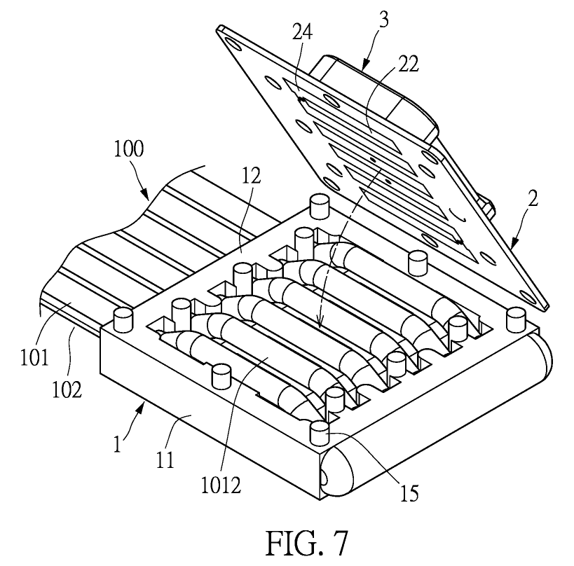

The circuit board 2 can be a flexible printed circuit board (FPC), and the circuit board 2 is flexible. The connector 3 is connected to the circuit board 2 by soldering, and the circuit board 2 can be used as an adapter board. By using the circuits on the circuit board 2, the circuits of the connector 3 can be adjusted to have same distances from each other as the plurality of elastic wires 101. Referring to FIGS. 6 and 7, a plurality of first contacts 21 and a plurality of second contacts 22 are respectively disposed on two sides of the circuit board 2, and the first contacts 21 and the second contacts 22 are metal contacts. The connector 3 has a plurality of pins 31, and the first contacts 21 can be respectively connected by soldering to the plurality of pins 31 of the connector 3, such that the connector 3 is fixed on the circuit board 2, and the circuit board 2 and the connector 3 are in electrical connection. In the connecting device of the present disclosure, the connector 3 and the circuit board 2 can be connected to each other using a thermal process before connecting the elastic wires 101, so as to avoid affecting the elastic wires 101 in subsequent assembly processes, without requiring the use of a thermal process to connect the elastic wires 101 and the connector 3.

In the present disclosure, the fixing seat 1 is assembled with the elastic wire assembly 100, and by the effect of a friction force generated from the elastic wire assembly 100 passing through the fixing seat 1, the fixing seat 1 is fixed to the elastic wire assembly 100. The lifting structure 13 is disposed at a center of the bottom side of the fixing seat 1 to lift the elastic wire assembly 100 upward (as shown in FIG. 3). Accordingly, the lifting structure 13 can provide a contact force, that is, provide a positive force for the elastic wire assembly 100.

The circuit board 2 is disposed on the fixing seat 1, and surfaces of the plurality of elastic wires 101 has insulating paint. The insulating paint can be removed by laser, such that electrical conductor bodies 1012 inside of the elastic wires 101 (as shown in FIG. 7) are exposed for being assembled with the circuit board 2. The circuit board 2 includes the plurality of second contacts 22 that correspond to the plurality of elastic wires 101, and the circuit board 2 presses against the protruding portions 1011 of the plurality of elastic wires 101, such that protruding height parts of the plurality of protruding portions 1011 of the plurality of elastic wires 101 are respectively pressed tightly to be in contact with the plurality of second contacts 22 of the circuit board 2. Since the protruding portions 1011 of the plurality of elastic wires 101 are in contact with the second contacts 22 of the circuit board 2, a reliable contact can be achieved, and the fixing seat 1 and the circuit board 2 can clamp the elastic wire assembly 100. In addition, conductive glue 24 (as shown in FIG. 7) may be respectively disposed between the plurality of elastic wires 101 and the plurality of second contacts 22 to improve the conduction effect.

In this embodiment, the fixing seat 1 includes a plurality of positioning posts 15, and the circuit board 2 includes a plurality of positioning holes 23. The plurality of positioning posts 15 respectively cooperate with the plurality of positioning holes 23, such that the fixing seat 1 and the circuit board 2 are stably positioned. In addition, parts of the positioning posts 15 above the circuit board 2 can be flattened by heat-pressing, excessive parts of the elastic wires 101 at lateral sides of the fixing seat 1 can be cut off, and an encapsulant 16 (as shown in FIG. 8) for insulating and fixing the elastic wires 101 can be disposed by glue-dispensing. The encapsulant 16 is disposed on the fixing seat 1 to fix the elastic wires 101 in place and insulate the elastic wires 101.

### Beneficial Effects of the Embodiments

In conclusion, one of the beneficial effects of the present disclosure lies in that, the connecting device provided by the present disclosure includes a fixing seat, a circuit board and a connector. The fixing seat includes two cross bars and a lifting structure. The lifting structure is disposed between the two cross bars. A through hole is formed between the lifting structure and the two cross bars, such that the elastic wire assembly is able to pass through the through hole. Accordingly, the elastic wire assembly can pass through bottom sides of the two cross bars and a top side of the lifting structure, and the elastic wire assembly is bent and passes through the fixing seat. A plurality of first contacts and a plurality of second contacts are respectively disposed on two opposite sides of the circuit board. The first contacts are respectively soldered to a plurality of pins of the connector, and the circuit board is disposed on the fixing seat. The plurality of elastic wires are lifted by the lifting structure, such that each of the plurality of elastic wires respectively form one of a plurality of protruding portions, and the plurality of protruding portions of the plurality of elastic wires are respectively in contact with the plurality of second contacts of the circuit board, such that the plurality of elastic wires are electrically connected to the connector through the circuit board. In the present disclosure, a friction force from the elastic wire assembly passing through the fixing seat is used to fix the elastic wire assembly and the fixing seat in place, and the friction force between the elastic wire assembly and the fixing seat is increased. The structure of the fixing seat bends to form a path through which the elastic wire assembly passes, thereby increasing the friction force between the elastic wire assembly and the fixing seat and preventing the elastic wire assembly from easily falling off from the fixing seat. Accordingly, the fixing seat and the circuit board can clamp the elastic wire assembly. In addition, the expansion force of the plurality of elastic wires after compression allows the plurality of elastic wires to be better attached to the circuit board for electrical conduction. The connecting device of the present disclosure can facilitate the connection between the elastic wire and the connector without requiring the use of a thermal process to connect the elastic wire and the connector, so as to avoid damaging the elastic wire.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A connecting device for connecting an elastic wire assembly, wherein the elastic wire assembly includes a plurality of elastic wires, and the connecting device comprises:
a fixing seat including two cross bars and a lifting structure, wherein the two cross bars are spaced apart from each other, the lifting structure is disposed between the two cross bars, and a through hole is formed between the lifting structure and the two cross bars; and wherein the elastic wire assembly is able to pass through the through hole, so that the elastic wire assembly passes through bottom sides of the two cross bars and a top side of the lifting structure, and the elastic wire assembly is bent and passes through the fixing seat;
a circuit board, wherein a plurality of first contacts and a plurality of second contacts are respectively disposed on two opposite sides of the circuit board; and
a connector including a plurality of pins, wherein the first contacts are respectively soldered to the plurality of pins of the connector, and the circuit board is disposed on the fixing seat;
wherein the plurality of elastic wires are lifted by the lifting structure, so that each of the plurality of elastic wires respectively form one of a plurality of protruding portions, and the plurality of protruding portions of the plurality of elastic wires are respectively in contact with the plurality of second contacts of the circuit board, so that the plurality of elastic wires are electrically connected to the connector through the circuit board.

2. The connecting device according to claim 1, wherein the fixing seat further includes two side bars, and two ends of each of the two cross bars are connected to two ends of each of the two side bars, respectively, and two ends of the lifting structure are respectively connected to the two side bars.

3. The connecting device according to claim 1, wherein the lifting structure is disposed at a center of a bottom side of the fixing seat, and the lifting structure is equidistant from the two cross bars.

4. The connecting device according to claim 1, wherein the plurality of elastic wires are connected to a double-sided adhesive tape, and the double-sided adhesive tape of a position on the elastic wire assembly corresponding to the lifting structure is removed, so that the lifting structure is in contact with the plurality of elastic wires.

5. The connecting device according to claim 1, wherein the two cross bars and the lifting structure are located at different horizontal heights, a horizontal height of the two cross bars is higher than a horizontal height of the lifting structure, and the lifting structure is located on a bottom side of the fixing seat.

6. The connecting device according to claim 1, wherein a plurality of first wire grooves are formed at intervals on the two cross bars, and a plurality of second wire grooves are formed at intervals on the lifting structure; and wherein the plurality of first wire grooves are arranged on the bottom sides of the two cross bars, the plurality of second wire grooves are arranged on a top side of the lifting structure, and the plurality of elastic wires are respectively accommodated in the plurality of first wire grooves and the plurality of second wire grooves.

7. The connecting device according to claim 1, wherein conductive glue is respectively disposed between the plurality of elastic wires and the plurality of second contacts.

8. The connecting device according to claim 1, wherein the fixing seat includes a plurality of positioning posts, and the circuit board includes a plurality of positioning holes; and wherein the plurality of positioning posts respectively cooperate with the plurality of positioning holes, and parts of the plurality of positioning posts above the circuit board are flattened by heat-pressing.

9. The connecting device according to claim 1, wherein protruding height parts of the plurality of protruding portions of the plurality of elastic wires are respectively pressed tightly to be in contact with the plurality of second contacts of the circuit board, the plurality of protruding portions are strip-shaped, and a length of each the plurality of protruding portions is greater than a diameter of each of the plurality of elastic wires.

10. The connecting device according to claim 1, wherein the circuit board presses against the plurality of protruding portions of the plurality of elastic wires, so that the plurality of protruding portions of the plurality of elastic wires are pressed to be in tight contact with the plurality of second contacts of the circuit board, respectively.
